(19) United States
(12) Patent Application Publication
(10) Pub. No.: US 2004/0078449 A1
(43) Pub. Date: Apr. 22, 2004

(54) Master communication device, slave communication device, communication control apparatus, communication system, and communication control program

(75) Inventors: Shingo Tanaka, Kanagawa-Ken (JP); Masataka Goto, Kanagawa-Ken (JP); Naoki Esaka, Kanagawa-Ken (JP)

Correspondence Address: Finnegan, Henderson, Farabow, Garrett & Dunner, L.L.P., 1300 I Street, N.W., Washington, DC, 20005-3315, US

(73) Assignee: KABUSHIKI KAISHA TOSHIBA

(21) Appl. No.: 10/671,804

(22) Filed: Sep. 29, 2003

(30) Foreign Application Priority Data
Sep. 30, 2002 (JP) 2002-287534

(51) Int. Cl. G06F 15/16

(52) U.S. Cl. 709/208; 709/201

(57) ABSTRACT

A master communication device capable of simultaneously communicating with slave communication devices within a limited number prescribed in advance, comprising: a communication judgment unit which judges whether or not one of the slave communication devices which has issued communication request is currently connected; a communication connection unit which connects the slave communication device judged not to be connected by the communication judgment unit; a connected number judgment unit which judges whether or not the number of the slave communication devices connected currently reaches a prescribed number not more than the limited number; a release selection unit which selects at least one of the slave communication devices to be released, when determined to have reached the prescribed number; and a communication release unit which releases the selected slave communication device.

### CROSS REFERENCE TO RELATED APPLICATIONS

This application claims benefit of priority under 35USC §119 to Japanese Patent Application No. 2002-287534, filed on Sep. 30, 2002, the entire contents of which are incorporated by reference herein.

### BACKGROUND OF THE INVENTION

1. Field of the Invention

The present invention relates to a master communication device, a slave communication device, a communication control apparatus, a communication system, and a communication control program used in the communication system, in which the master communication device can communicate with a plurality of slave communication devices at the same time.

2. Related Art

With progress and development of information technology in recent years, a communication function is now being mounted in not only PCs and servers, but also mobile equipment such as PDA and mobile phones, household electrical appliances, and sensors, which have not heretofore been handled as a computer.

As a communication function for connecting them, there is one referred to as Bluetooth (™). The Bluetooth uses radio signals in a 2.4 GHz band, and can be miniaturized, with the cost of parts being inexpensive. Hence, the use thereof is expected as a simple communication module in the communication equipment described above.

The Bluetooth uses a connection mode called as a piconet, in which a plurality of slave devices are connected to one master device. According to the standard, the number of the slave devices that can be connected to one piconet is 7 at maximum, and no more. However, when the slave device is set in an electric power saving mode, called as a park mode, more than 7 slave devices can be connected to one piconet, exceptionally.

The Bluetooth utilizes a frequency hopping technique for wireless communication, in which certain synchronization between the master device and the slave device is maintained. At the time of connection, synchronization may take some time, for example, several seconds at most. Therefore, in the case where communication is not performed usually, but communication becomes suddenly necessary sometimes, the speed of response is slow, and hence there may be a problem in changing over from the released state to the connected state, according to the application.

The park mode is used for such a case. The slave device in the park mode cannot exchange data with the master device (except of piconet broadcast), and hence is not counted as one of the above seven slave devices, but is maintained in a state with synchronization described above.

Therefore, the slave device in the park mode can shift from the park mode to the connected state within a relatively short period of time (about several hundreds msec.), and can start data communication immediately thereafter. By this park mode, up to 255 slave devices, which can resume the connected state in a moment as required, can be connected simultaneously to one piconet, according to the standard.

There have already been patents relating to the park mode at present. A technique is disclosed in which one to one communication between a master device and a slave device is assumed, and when communication is necessary, the slave device shifts from the park mode to the connected state, and thereafter, when a certain period of time has passed without any communication being performed, the slave device shifts again to the park mode (see, for example, Japanese Patent Application No. 2002-152439).

Moreover, also a technique is disclosed in which communication between one master device and a plurality of slave devices is assumed, and the master device queues slave devices to be connected preferentially, separately from other slave devices, so as to set up connection with the slave device selectively based on the information (see Japanese Patent Application No. 2002-149510).

When various mobile equipment, household electrical appliances, and sensors perform communication, as in the house network, the respective communication quantities are relatively small, but the number of communication equipment inevitably increases.

However, it is common that there is an upper limit in the number of equipment to be connected in the communication standard, particularly, in the wireless communication standard, and hence lots of equipment cannot be accommodated in the network. Therefore, it is necessary to selectively change over connection and release of equipment by some method. In the Bluetooth, an effective method called as the park mode is defined for temporary release. However, this is only a method for release, and how to use this method with respect to the respective slave devices in the whole piconet is not defined, and this matter is left to developers.

The Japanese Patent Application No. 2002-149510 described above proposes one solution. In this document, however, the timing for connecting the master and a slave in the released state is not described. Accordingly, when it is needed to transmit data, the time until the data is actually transmitted may become long.

Therefore, the subject of the present invention is to make it possible to transmit data such that when communication equipment exists in the number exceeding the number that can be accommodated in the network, optional equipment which needs to transmit data among them, can be immediately connected by best effort method to transmit data.

### SUMMARY OF THE INVENTION

In view of the above situation, it is an object of the present invention to provide a master communication device, a slave communication device, a communication control apparatus, a communication system, and a communication control program, wherein when communication equipment exists in the number exceeding the number that can be accommodated in the network, optional slave communication device which needs to transmit data can be immediately connected by best effort method, to transmit data.

A master communication device capable of simultaneously communicating with slave communication devices within a limited number prescribed in advance, comprising:

a communication judgment unit configured to judge whether or not one of said slave communication devices which has issued communication request is currently connected;

a communication connection unit configured to connect said slave communication device judged not to be connected by said communication judgment unit;

a connected number judgment unit configured to judge whether or not the number of said slave communication devices connected currently reaches a prescribed number not more than said limited number;

a release selection unit configured to select at least one of said slave communication devices to be released, when determined to have reached said prescribed number; and

a communication release unit configured to release the selected slave communication device.

Furthermore, a slave communication device used in a communication system having a master communication device which can simultaneously communicate with slave communication devices within a limited number prescribed in advance, and a communication control apparatus which controls said slave communication devices connected to said master communication device, comprising:

a master communication device connection determination unit configured to determine whether or not to be connected to said master communication device when communication request for said master communication device has been issued;

a release report signal transmission unit configured to transmit release report to said communication control apparatus, when connection for said master communication device is released; and

a connection release unit configured to release connection for said master communication unit when release instruction for said master communication device is received from said communication control apparatus, during being connected to said master communication device.

Furthermore, a communication control apparatus which controls a slave communication device connected to a master communication device capable of simultaneously communicating with said slave communication device within a limited number prescribed in advance, comprising:

a connection report receiving unit configured to receive a connection report from said slave communication device newly connected to said master communication device;

a connection information registration unit configured to register information relating to said slave communication device currently connected to said master communication device;

a connected number judgment unit configured to judge that the number of said slave communication device connected to said master communication device reaches a prescribed number not more than the limited number, based on information registered in said connection information registration unit;

a communication device selection unit configured to select at least one of said slave communication devices that connection for said master communication device is to be released, when determined to have reached said prescribed number; and

a release instruction unit configured to transmit release instruction to said slave communication device selected by said communication device selection unit.

Furthermore, a communication system, comprising:

at least one of slave communication devices; and

a master communication device configured to be able to communicate simultaneously with said slave communication device within a limited number prescribed in advance,

wherein said master communication device includes:

a communication judgment unit configured to judge whether or not one of said slave communication devices which has issued communication request is currently connected;

a communication connection unit configured to connect said slave communication device determined not to be connected by said communication judgment unit;

a connected number judgment unit configured to judge whether or not the number of said slave communication devices connected currently reaches a prescribed number not more than said limited number;

a release selection unit configured to select at least one of said slave communication devices to be released, when determined to have reached said prescribed number; and

a communication release unit configured to release the selected slave communication device.

### BRIEF DESCRIPTION OF THE DRAWINGS

FIG. 1 is a diagram showing schematic configuration of a communication device according to a first embodiment of the present invention.

FIG. 2 is a block diagram showing the internal configuration of the master device 1, being the first embodiment of the master communication device according to the present invention.

FIG. 3 is a block diagram showing the internal configuration of the slave device 2, being the first embodiment of the slave communication device according to the present invention.

FIG. 4 is a flowchart indicating a processing procedure of the master device 1 according to the present invention.

FIG. 5 is a block diagram showing a modified example of a master device.

FIG. 6 is a block diagram showing the other modified example of a master device.

FIG. 7 is a block diagram showing internal configuration of a master device according to a second embodiment.

FIG. 8 is a flowchart showing processing procedure of a master device according to a second embodiment.

FIG. 9 is a block diagram showing entire configurations of a communication system according to a third embodiment of the present invention.

FIG. 10 is a block diagram showing internal configurations of a slave device of FIG. 9.

FIG. 11 is a block diagram showing internal configurations of a communication control device of FIG. 9.

FIG. 12 is a flowchart showing processing procedure of a slave device of FIG. 10.

FIG. 13 is a flowchart showing processing procedure of a communication control device of FIG. 11.

### DESCRIPTION OF THE PREFERRED EMBODIMENTS

A master communication device, a slave communication device, a communication control apparatus, a communication system, and a communication control program according to the present invention will be described specifically, with reference to the drawings.

(First Embodiment)

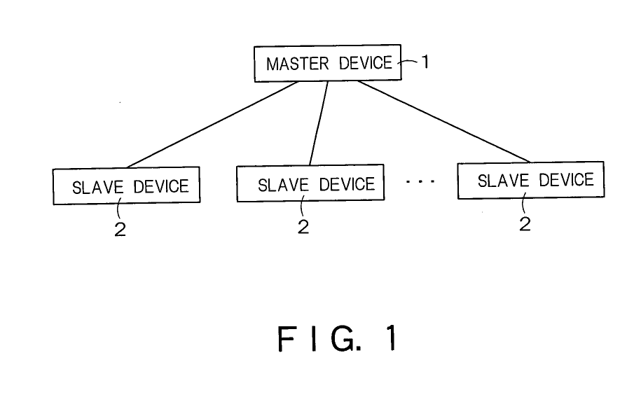

A communication system in which wireless communication is performed according to specification of the Bluetooth will be described as one example. In the communication of this embodiment, as shown in FIG. 1, a master device 1 and a plurality of slave devices 2 exist, and up to seven slave devices 2 can be connected to the master device 1. However, when a slave device 2 is set in the park mode, which is an electric power saving mode, this slave device 2 is not counted as one of the seven slave devices, but still can be connected to the master device 1. In other words, the slave device 2 set in the park mode is not counted in the number of devices to be connected. Therefore, it is a characteristic point in this embodiment that the slave devices 2 which are not connected to the master device 1 are set in the park mode.

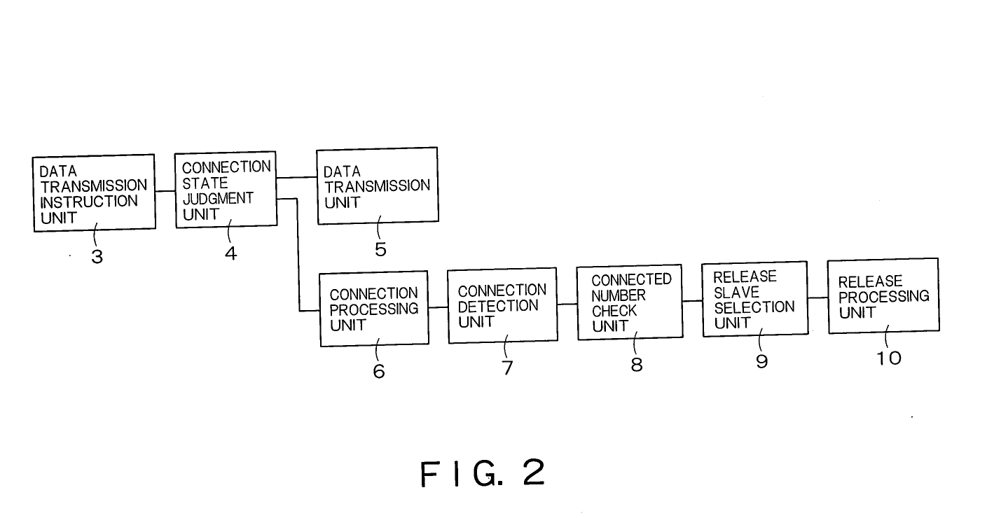

FIG. 2 is a block diagram showing the internal configuration of the master device 1, being the first embodiment of the master communication device according to the present invention. The master device 1 in FIG. 2 comprises a data transmission instruction unit 3 which instructs data transmission to the slave device 2, a connection state judgment unit 4 which judges the connection state of the slave device 2, a data transmission unit 5 which performs data transmission to the slave device 2, a connection processing unit 6 which performs connection processing with the slave device 2, a connection detection unit 7 which detects connection with the slave device 2, a connected number check unit 8 which checks the number of connected slave devices 2, a released slave device selection unit 9 which selects a slave device 2 to be released, and a release processing unit 10 which releases the slave device 2.

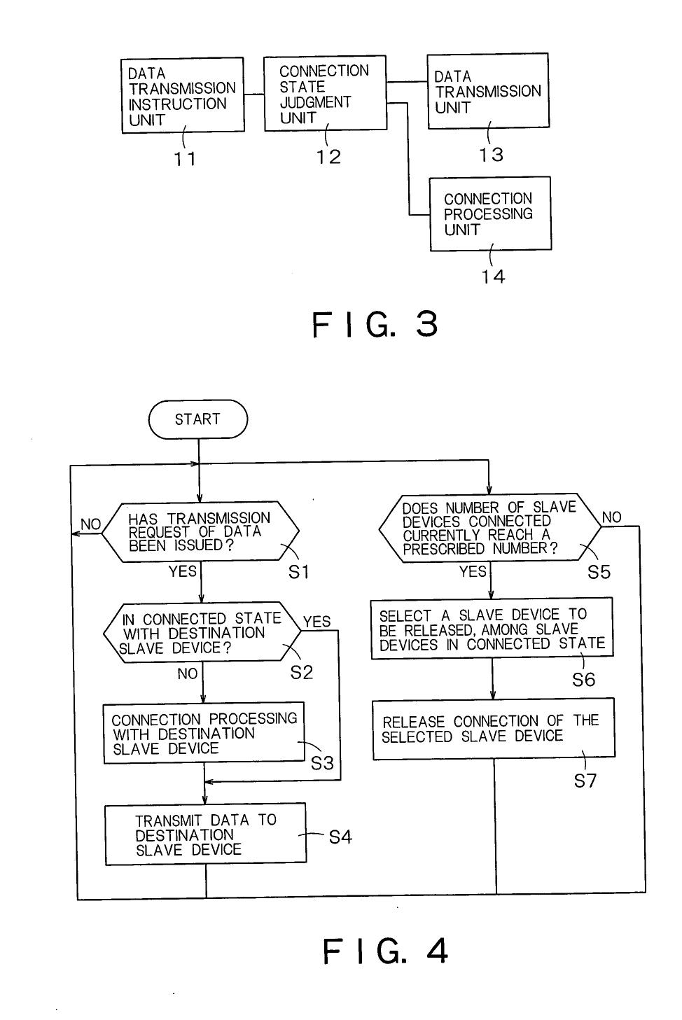

FIG. 3 is a block diagram showing the internal configuration of the slave device 2, being the first embodiment of the slave communication device according to the present invention. The slave device 2 of FIG. 3 comprises a data transmission instruction unit 11 which instructs data transmission to the master device 1, a connection state judgment unit 12 which judges the connection state with the master device 1, a data transmission unit 13 which performs data transmission to the master device 1, and a connection processing unit 14 which performs connection processing with the master device 1.

FIG. 4 is a flowchart indicating a processing procedure of the master device 1 according to the present invention. When starting the processing in FIG. 4, it is assumed that each of the slave device 2 is connected to the master device 1 in the park mode, and for example, sixteen slave devices 2 are connected to the master device 1 in the park mode.

At this time, it is assumed that the data transmission instruction unit 3 in the master device 1 has issued an instruction to send data to one slave device 2. By this instruction, the judgment result in step S1 in FIG. 4, in which it is judged whether there occurred a data transmission request, becomes YES, and the connection state judgment unit 4 judges whether the destination slave device 2 is in the connected state (step S2).

In this step S2, for example, when the destination slave device 2 is in the park mode, it is judged that the destination slave device 2 is not connected. As a result, the connection processing unit 6 performs connection processing with respect to the destination slave device 2 (step S3), and the data transmission unit 5 transmits data to the destination slave device 2 (step S4). Thereafter, control returns to step S1, to repeat each processing in steps S1 to S4.

Thereafter, for example, it is assumed that the data transmission instruction unit 3 has issued a data transmission instruction to the same slave device 2. In this case, the connection state judgment unit 4 judges that the slave device 2 is in the connected state, and the data transmission unit 5 continues data transmission as it is.

In parallel with the processings in the above steps S1 to S4, when the connection detection unit 7 detects a new connection with the destination slave device 2, the connected number check unit 8 checks if the number of currently connected slave devices 2 has reached a predetermined number (for example, 5) which is less than the limited number (7 in the case of Bluetooth) (step S5). If it is assumed that the number of the slave devices 2 currently connected is one, since the number is smaller than the predetermined number described above, the processing in step S5 is repeated.

Thereafter, when the data transmission instruction unit 3 has issued a data transmission instruction with respect to another unconnected slave device 3, the connection processing unit 6 shifts the slave device 2 from the park mode to the connected state, and the data transmission unit 5 transmits data. The connection detection unit 7 detects that the slave device 2 has been newly connected, and the connected number check unit 8 detects that currently two slave devices 2 are connected, but since the number is smaller than five, it judges NO in step s5.

It is assumed that as a result of repeating each processing in the above steps S1 to S4, the number of the slave devices 2 connected to the master device 1 has reached the predetermined number. In this case, the judgment result in step S5 becomes YES, and the released slave device selection unit 9 selects a slave device 2 to be released from the currently connected slave devices 2 (step S6), and releases the selected slave device 2 (step S7). Actually, the selected slave device 2 is shifted to the park mode.

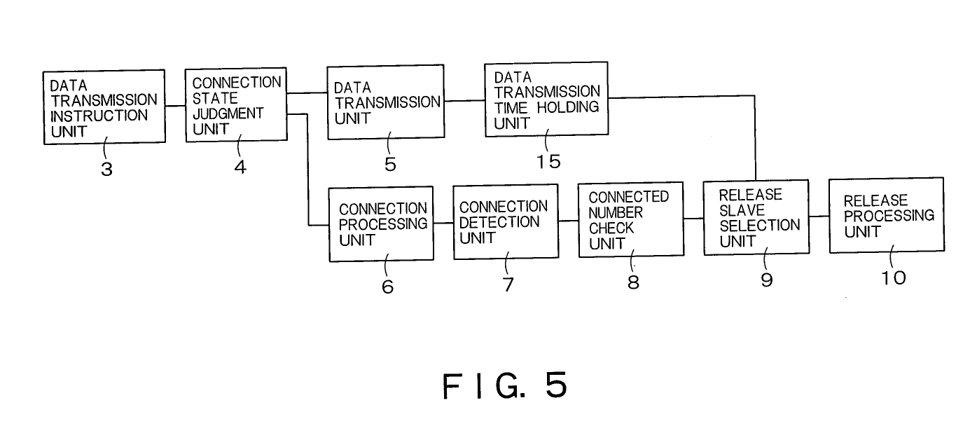

As the method for selecting the slave device 2 to be released, several methods can be considered. For example, a slave device 2 having the longest elapsed time since data communication with the master device 1 has been conducted lastly is selected. In this case, as shown in FIG. 5, a data transmission time holding unit 15, which holds the elapsed time since data communication with the master device 1 has been performed lastly, is provided in the master device 1, and the released slave device selection unit 9 selects the slave device 2 to be released, based on the information from the data transmission time holding unit 15.

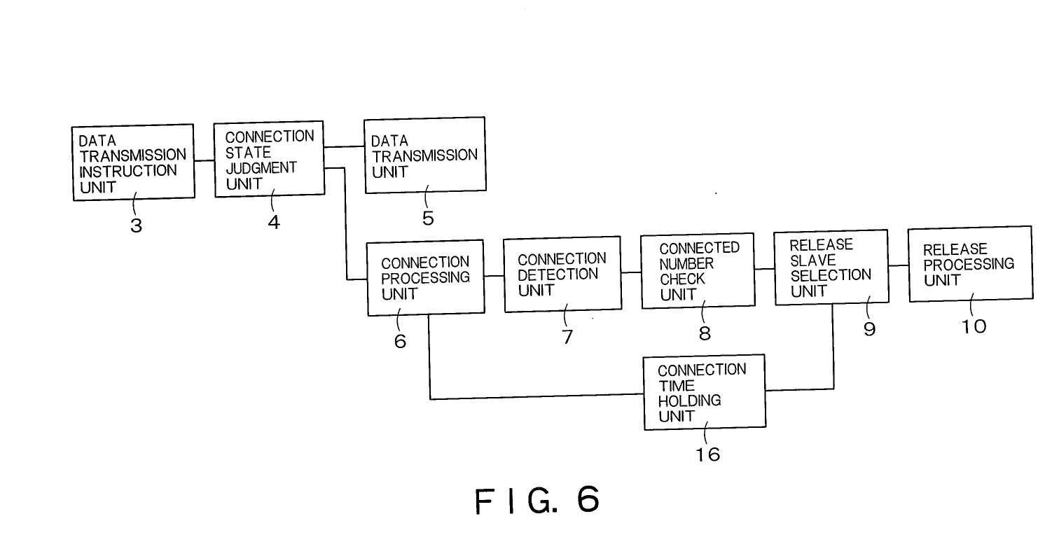

Alternatively, a slave device 2 having the longest connection time with the master device 1 may be selected. In this case, as shown in FIG. 6, a connection time holding unit 16, which measures the connection time with the master device 1, is provided in the master device 1, and the released slave device selection unit 9 selects the slave device 2 to be released, based on the information from the connection time holding unit 16.

In step S7, the slave device 2 is not physically released, but is set to the part mode. Even if the slave device 2 to be set in the park mode is performing data communication, and the slave device 2 is forcibly set in the park mode, no particular problem occurs. In this case, it can be considered that after having set the slave device 2 in the park mode, there has occurred a request for data communication with the master device 1, and the master device 1 executes the processing in FIG. 4, to attempt a connection to the slave device 2.

As described above, when the number of the slave devices 2 connected to the master device 1 has reached the predetermined number, any one of the slave devices 2 being connected to the master device 1 is released (set in the park mode). As a result, the slave device 2, which needs to transmit data, can transmit data quickly, and hence the time required for data transmission can be reduced.

Further, since the released slave device 2 is actually set in the park mode, it can be returned from the released state to the connected state quickly, thereby improving the responsiveness. By using the park mode, slave devices 2 of more than the limited number (7) can be apparently connected to the master device 1, and hence the size of the communication network can be enlarged.

(Second Embodiment)

In the second embodiment, a slave device 2 to be connected is selected based on a control list in which slave devices 2 waiting for the connection are registered.

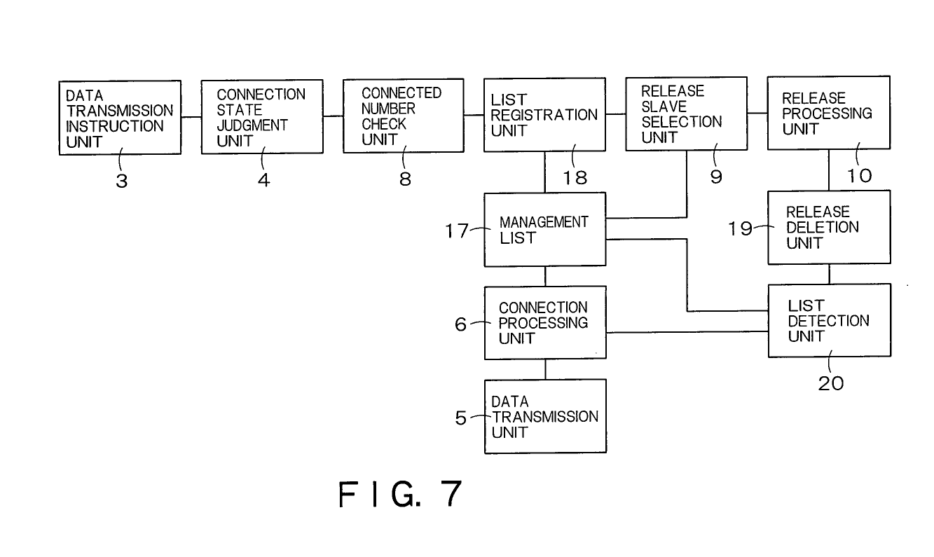

FIG. 7 is a block diagram showing the internal configuration of the master device 1 in the second embodiment. The master device 1 in FIG. 7 further comprises a control list 17 in which slave devices 2 waiting for the connection to the master device are registered, a list registration unit 18 which controls registration in the control list 17, a release detection unit 19 which detects that a slave device 2 has been released, and a list deletion unit 20 which selects a slave device 2 to be connected from the control list 17 and deletes the slave device 2 from the control list 17, in addition to the configuration shown in FIG. 2.

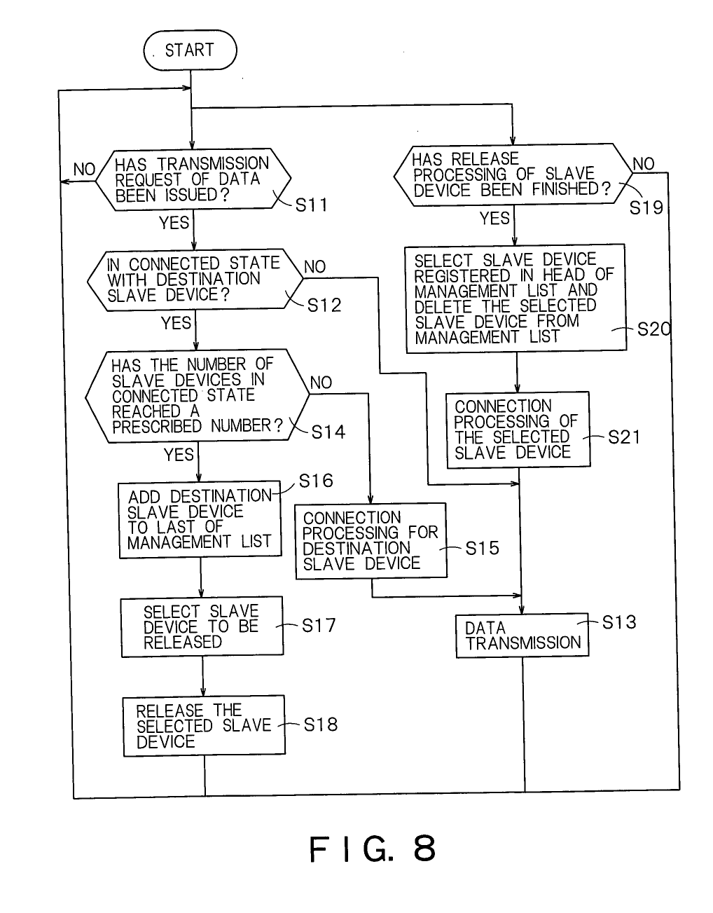

FIG. 8 is a flowchart indicating a processing procedure of the master device 1 in the second embodiment. At first, when the data transmission instruction unit 3 instructs data transmission to the destination slave device 2, the judgment result in step S11 becomes YES, and the connection state judgment unit 4 judges whether the destination slave device 2 has been already connected (step S12). If it has been already connected, the data transmission unit 5 starts to transmit data (step S13), and thereafter, control returns to the processing in step S11.

If the destination slave device 2 has not yet been connected, the connected number judgment unit 8 judges whether the number of connected slave devices 2 has reached the predetermined number (step S14), and if not, the connection processing unit 6 performs connection processing with respect to the destination slave device 2 (step S15), and the data transmission unit 5 starts transmission of data (step S13).

When the number of connected slave devices 2 has reached the predetermined number, the registration control unit adds the destination slave device 2 to the last line in the control list 17, in which the slave devices 2 waiting for the connection are registered (step S16).

The released slave device selection unit 9 selects a slave device 2 to be released (step S17), and the release processing unit 10 releases the selected slave device 2, that is, sets the selected slave device 2 in the park mode (step S18). Thereafter, processing in and after step S11 is repeated.

On the other hand, in parallel with each processing in steps S11 to S18, the release detection unit 19 judges whether the release processing of the slave device 2 has finished (step S19). If not, the processing in step S21 is repeated, and when the release processing has finished, the list deletion unit 20 selects the slave device 2 registered at the top of the control list 17, and deletes the selected slave device 2 from the control list 17 (step S20). The connection processing unit 6 performs the connection processing of the selected slave device 2 (step S21), and the data transmission unit 5 transmits data (step S13).

As described above, since each processing in steps S19 to S21 is performed asynchronously with each processing in steps S11 to S18, there is the possibility that a data transmission request is generated with respect to another slave device 2 before finishing the release processing of the slave device 2. Therefore, in this embodiment, the control list 17 is provided, so that the waiting slave devices 2 waiting for the connection are sequentially connected to the master device 1.

For example, when five slave devices 2 are connected to the master device 1, it is assumed that the master device 1 sequentially issues a data transmission instruction to the other three slave devices 2. In this case, the three slave devices 2 are registered in the control list 17 sequentially, selected one by one from the control list in order of registration, and connected to the master device 1, with the other slave devices 2 set in the park mode. By repeating this processing, the five slave devices 5 connected to the master device 1 are replaced.

Also in the second embodiment, when the connected slave device 2 is to be released, as in the first embodiment, a slave device 2 having the longest elapsed time since data communication with the master device 1 has been conducted lastly may be selected, or a slave device 2 having the longest connection time with the master device 1 may be selected.

(Third Embodiment)

It is a characteristic point in the third embodiment that a communication control apparatus which controls communication with the slave devices 2 is provided, in addition to the master device 1.

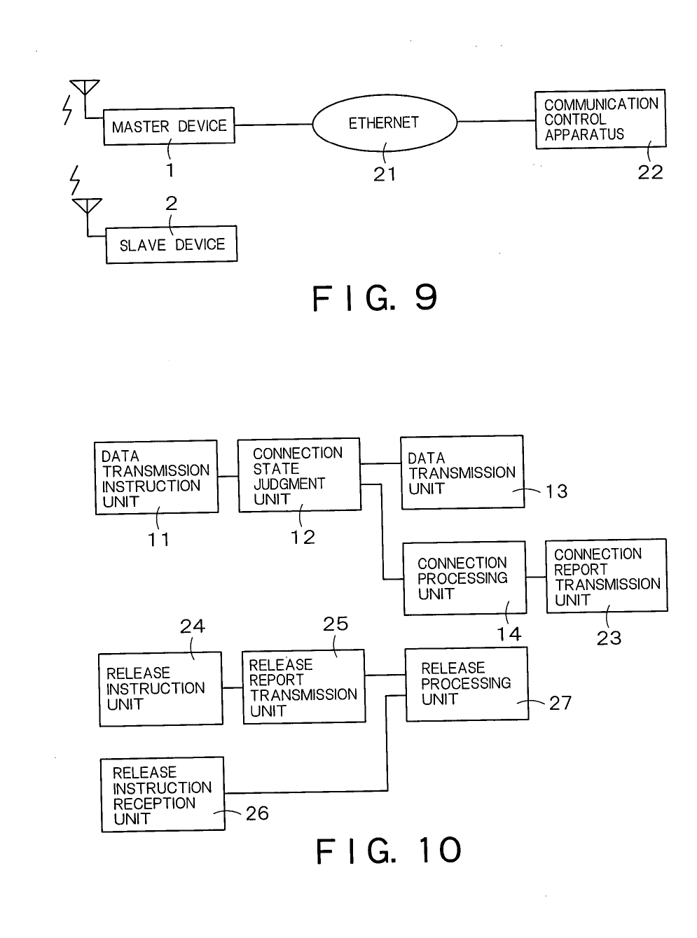

FIG. 9 is a block diagram illustrating the overall configuration of the communication system in the third embodiment of the present invention. As shown in this figure, the communication system comprises the master device 1 and slave devices 2, which perform wireless communication according to the specification of the Bluetooth, and a communication control apparatus 22 connected to the master device 1 by the Ethernet 21.

The master device 1 in FIG. 9 is constituted in the same manner as shown in FIG. 2 or FIG. 7. FIG. 10 is a block diagram showing the internal configuration of the slave device 2 shown in FIG. 9. As shown in FIG. 10, the slave device 2 comprises a connection report transmission unit 23 which reports connection with the master device 1 to the communication control apparatus 22, a release instruction unit 24 which instructs release from the master device 1, a release report transmission unit 25 which reports release from the master device 1 to the communication control apparatus 22, a release instruction reception unit 26 which receives a release instruction from the communication control apparatus 22, and a release processing unit 27 which performs release processing from the master device 1.

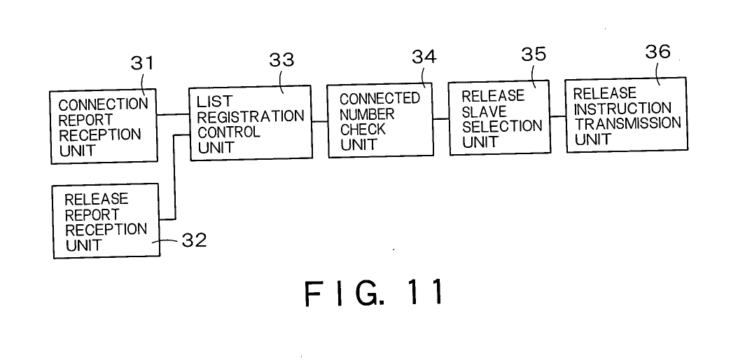

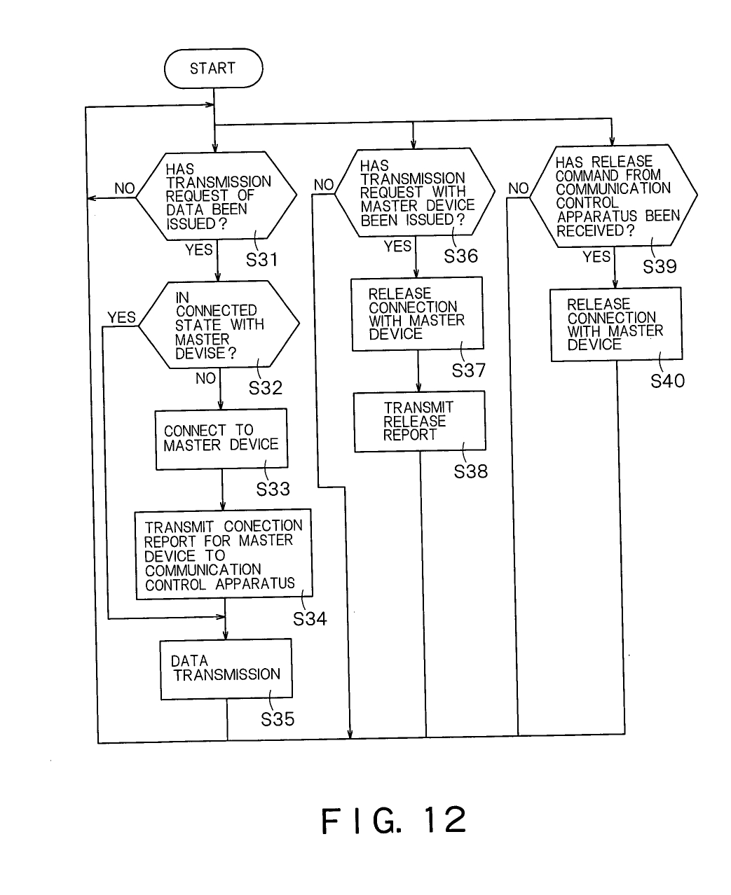

FIG. 11 is a block diagram showing the internal configuration of the communication control apparatus 22 shown in FIG. 9. As shown in FIG. 11, the communication control apparatus 22 comprises a connection report reception unit 31 which receives a connection report from the slave device 2, a release report reception unit 32 which receives a release report from the slave device 2, a list registration control unit 33 which controls registration of slave devices 2 currently connected with the master device 1 in the control list 17, a connected number check unit 34 which checks the number of the slave devices 2 currently connected to the master device 1, a released slave device selection unit 35 which selects a slave device 2 to be released, and a release instruction transmission unit 36 which transmits a release instruction from the master device 1 to a specific slave device 2.

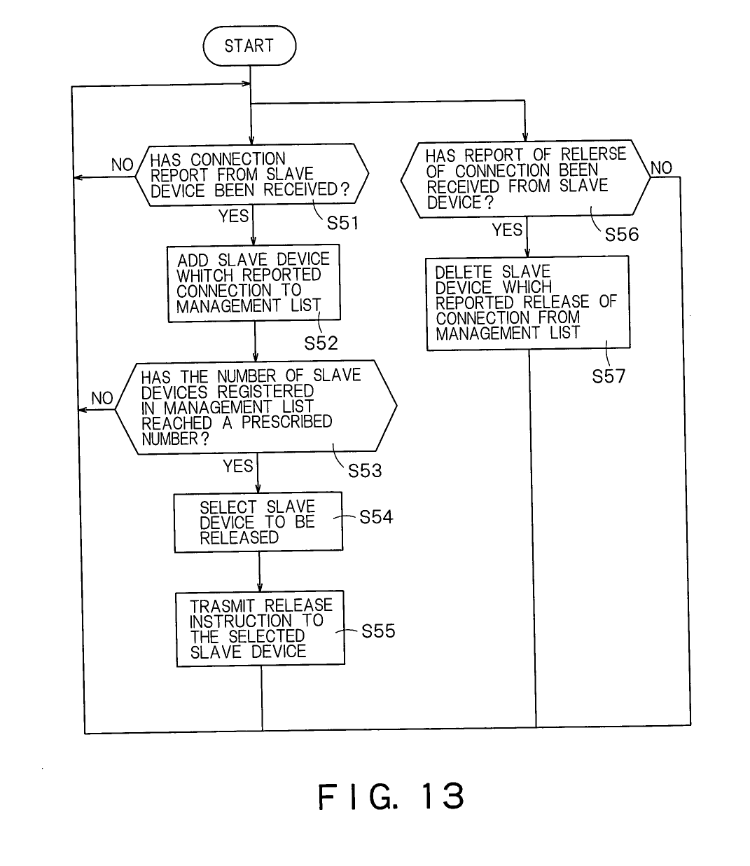

FIG. 12 is a flowchart indicating a processing operation of the slave device 2 shown in FIG. 10. When the data transmission instruction unit 11 in a certain slave device 2 instructs data transmission with respect to the master device 1, the judgment result in step S31 becomes YES, and the connection state judgment unit 4 judges whether the slave device 2 is currently connected to the master device 1, that is, whether it is not in the park mode (step S32). If it is not connected to the master device 1, the connection processing unit 6 connects the slave device 2 to the master device 1 (step S33), and the connection report transmission unit 23 transmits a connection report to the communication control apparatus 22 (step S34).

After the processing in step S34 has finished, or when the judgment result in step S32 is YES, the data transmission unit 5 transmits data to the master device 1 (step S35).

In parallel with each processing in steps S31 to S35, it is judged whether there has occurred a release request from the master device 1 (step S36). Here, when there is a release instruction from the release instruction unit, the judgment result in step S36 becomes YES. When the judgment result in step S36 becomes YES, the release processing unit 27 releases the slave device 2 from the master device 1 (step S37), and thereafter, the release report reception unit 32 transmits a release report to the communication control apparatus 22 (step S38), and control returns to step S36.

In parallel with each processing in steps S31 to S35, and steps S36 to S38, the release instruction reception unit 26 in the slave device 2 judges if it receives a release instruction from the communication control unit 22 (step S39). If not, the processing in step S39 is repeated, and when it has received a release instruction, the release processing unit 27 releases the slave device 2 from the master device 1 (step S40), and control returns to step S39.

FIG. 13 is a flowchart indicating a processing operation of the communication control apparatus 22. The connection report reception unit 31 in the communication control apparatus 22 judges whether it has received a connection report from the slave device 2 (step S51). If not, control stays in step S51, and when it receives a connection report, the list registration control unit 33 adds the slave device 2, from which the connection report has been received, in the control list 17 (step S52).

Then, the connected number check unit 34 judges whether the number of the slave devices 2 registered in the control list 17 has reached the predetermined number (step S53). If not, control returns to step S61, and if the number of the slave devices 2 has reached the predetermined number, the release slave device selection unit 35 selects the slave device 2 to be released (step S54). The selection method about the slave device 2 to be released is not particularly limited, and for example, a slave device 2 having the longest connection time may be selected, or also a slave device 2, which has not performed data communication with the master device 1 for the longest time, may be selected.

The release instruction transmission unit 36 transmits a release instruction (step S55), and control returns to step S51.

In parallel with each processing in steps S51 to S55, the release report reception unit 32 judges whether it has received a release report from the slave device 2 (step S56). If not, control stays in step S56, and if it receives a release report, the list registration control unit 33 deletes the slave device 2, from which the release report has been received, from the control list 17 (step S57), and control returns to step S56.

As described above, in the third embodiment, the communication control apparatus 22 is provided separately from the master device 1, so that the communication control apparatus 22 controls the slave devices 2 to be connected to the master device 1. As a result, the processing load of the master device 1 is reduced. In order to release the slave device 2 connected to the master device 1, the slave device 2 is set in the park mode, and hence return to the connection state can be made at a high speed.

In the first to the third embodiments, a slave device 2, which has not performed data communication with the master device 1 for the longest time, may be selected to be released.

In the first to the third embodiments, a case in which data is transmitted from the slave device 2 to the master device 1 has been mainly described, but the present invention is also applicable to a case in which the slave device 2 receives data from the master device 1.

The communication system described in the above embodiments may be composed of hardware, or software. When the communication system is composed of software, a program for realizing the function of the communication system may be stored in a recording medium such as a floppy disk or a CD-ROM, to be read into a computer and executed. The recording medium is not limited to a portable medium such as a magnetic disk and an optical disk, but may be a fixed recording medium such as a hard disk drive and a memory.

A program for realizing the function of the communication system may be distributed via a communication line (including wireless communication) such as Internet. Moreover, the program may be encoded, modulated or compressed, and distributed via a wire circuit or a radio link such as Internet, or distributed by storing in a recording medium.

What is claimed is:

1. A master communication device capable of simultaneously communicating with slave communication devices within a limited number prescribed in advance, comprising:
a communication judgment unit configured to judge whether or not one of said slave communication devices which has issued communication request is currently connected;
a communication connection unit configured to connect said slave communication device judged not to be connected by said communication judgment unit;
a connected number judgment unit configured to judge whether or not the number of said slave communication devices connected currently reaches a prescribed number not more than said limited number;
a release selection unit configured to select at least one of said slave communication devices to be released, when determined to have reached said prescribed number; and
a communication release unit configured to release the selected slave communication device.

2. The master communication device according to claim 1, further comprising:
a waiting registration unit configured to register in order said slave communication device which issues said communication request, when determined to have reached said prescribed number; and
a communication connection unit configured to select and connects at least one of said slave communication device in order registered in said waiting registration unit.

3. The master communication device according to claim 1, wherein said release selection unit selects by priority said slave communication device which has performed the earliest communication among said slave communication devices connected currently.

4. The master communication device according to claim 1, wherein said release selection unit selects by priority the slave communication device which has been connected for the longest time among said slave communication devices connected currently.

5. The master communication device according to claim 1, further comprising a connection release unit configured to release connection for said slave communication device, when the connected slave communication device has not performed data transferring during not less than a prescribed period.

6. The master communication device according to claim 1, wherein release of connection for said slave communication device is performed by setting said slave communication device to be in a electric power saving mode.

7. The master communication device according to claim 6, wherein communication for said slave communication device is performed according to a specification of Bluetooth;
said master communication device is a master equipment;
said slave communication device is a slave equipment; and
said electric power saving mode is a park mode.

8. The master communication device according to claim 1, wherein communication for slave communication device is performed according to a specification of Bluetooth.

9. A slave communication device used in a communication system having a master communication device which can simultaneously communicate with slave communication devices within a limited number prescribed in advance, and a communication control apparatus which controls said slave communication devices connected to said master communication device, comprising:
a master communication device connection determination unit configured to determine whether or not to be connected to said master communication device when communication request for said master communication device has been issued;
a release report signal transmission unit configured to transmit release report to said communication control apparatus, when connection for said master communication device is released; and
a connection release unit configured to release connection for said master communication unit when release instruction for said master communication device is received from said communication control apparatus, during being connected to said master communication device.

10. The slave communication device according to claim 9, wherein said communication for said master communication device is performed according to a specification of Bluetooth; and
release of connection for said master communication device is performed by setting in a park mode.

11. A communication control apparatus which controls a slave communication device connected to a master communication device capable of simultaneously communicating with said slave communication device within a limited number prescribed in advance, comprising:
a connection report receiving unit configured to receive a connection report from said slave communication device newly connected to said master communication device;
a connection information registration unit configured to register information relating to said slave communication device currently connected to said master communication device;
a connected number judgment unit configured to judge that the number of said slave communication device connected to said master communication device reaches a prescribed number not more than the limited number, based on information registered in said connection information registration unit;
a communication device selection unit configured to select at least one of said slave communication devices that connection for said master communication device is to be released, when determined to have reached said prescribed number; and
a release instruction unit configured to transmit release instruction to said slave communication device selected by said communication device selection unit.

12. The slave communication device according to claim 11, wherein communication between said master communication device and said slave communication device is performed according to a specification of Bluetooth; and
a release of connection between said master communication device and said slave communication device is performed to be set in a park mode.

13. A communication system, comprising:
at least one of slave communication devices; and
a master communication device configured to be able to communicate simultaneously with said slave communication device within a limited number prescribed in advance,
wherein said master communication device includes:
a communication judgment unit configured to judge whether or not one of said slave communication devices which has issued communication request is currently connected;
a communication connection unit configured to connect said slave communication device determined not to be connected by said communication judgment unit;
a connected number judgment unit configured to judge whether or not the number of said slave communication devices connected currently reaches a prescribed number not more than said limited number;
a release selection unit configured to select at least one of said slave communication devices to be released, when determined to have reached said prescribed number; and
a communication release unit configured to release the selected slave communication device.

14. The communication system according to claim 13, wherein said master communication device includes:
a waiting registration unit configured to register said slave communication device which has issued said communication request in order, when determined to have reached said prescribed number; and
a communication connection unit configured to select and connects at least one of said slave communication devices in order registered to said waiting registration unit.

15. The communication system according to claim 13, wherein said slave communication device includes:
a master communication device connection judgment unit configured to judge whether or not to be connected to said master communication device, when communication request for said master communication device has been issued;
a release report signal supply unit configured to transmit a release report to said communication control apparatus when connection for said master communication device is released; and
a connection release unit configured to release connection for said master communication device when release instruction for said master communication device is received from said communication control apparatus, during being connected to said master communication apparatus,
wherein said communication control apparatus includes:
a connection report receiving unit configured to receive a connection report from said slave communication device newly connected to said master communication device;
a connection information registration unit configured to register information relating to said slave communication devices currently connected to said master communication device;
a connected number judgment unit configured to judge whether or the number of said slave communication device reaches a prescribed number not more than said limited number, based on the information registered to said connection information registration unit;
a communication device selection unit configured to select at least one of said slave communication devices of which connection for said master communication device is to be released, when determined to have reached said prescribed number; and
a release instruction unit configured to transmit release instruction to said slave communication device selected by said communication device selection unit.

16. The slave communication device according to claim 13, wherein communication between said master communication device and said slave communication device is performed according to a specification of Bluetooth; and
a release of connection between said master communication device and said slave communication device is performed by setting in a park mode.

17. A communication control program capable of reading by a computer which performs communication between at least one of slave communication devices, and a master communication device capable of simultaneously communicating with said slave communication devices within a limited number prescribed in advance, comprising:
judging by said master communication device whether or not one of said slave communication devices which has issued communication request is connected currently;
connecting said slave communication devices judged that said slave communication device is not connected currently, to said master communication device;
judging by said master communication device whether or not the number of said slave communication devices connected currently reaches a prescribed number not more than said a limited number;
selecting by said master communication device at least one of said slave communication devices to be released, when determined to have reached said prescribed number; and
releasing the selected slave communication device by said master communication device.

18. The communication control program according to claim 17, further comprising:
judging by said master communication device whether or not one of said slave communication devices which has issued communication request is connected currently;
judging by said master communication device whether or not the number of said slave communication devices connected currently reaches a prescribed number not more than said limited number;
registering in order said slave communication device which has issued the communication request to a waiting registration unit of said master communication device, when determined to have reached said prescribed number;
selecting by said master communication device at least one of said slave communication devices to be released, when determined to have reached said prescribed number; and
selecting at least one of said slave communication devices and connecting it to said master communication device, in order registered to said waiting registration unit.

19. The communication control program according to claim 17, comprising:
judging by said slave communication devices whether or not to be connected to said master communication device, when communication request for said master communication device is issued;
transmitting a release report from said slave communication device to said communication control apparatus when connection for said master communication device is released;
releasing connection between said master communication device and said slave communication device when a release instruction for said master communication device is received from said communication control apparatus, during being connected to said master communication device;
receiving by said communication control apparatus a connection report from said slave communication devices newly connected to said master communication device;
registering information relating to said slave communication devices currently connected to said master communication device, to said communication control apparatus;
judging by said communication control apparatus whether or not the number of said slave communication devices connected to said master communication device reaches a prescribed number not more than said limited number, based on the registered information;
selecting by said communication control apparatus at least one of said slave communication devices of which connection for master communication device is to be released, when determined to have reached said prescribed number; and
transmitting a release instruction from said communication control apparatus to the selected slave communication device.

20. The slave communication device according to claim 17, wherein communication between said master communication device and said slave communication device is performed according to a specification of Bluetooth; and
a release of connection between said master communication device and said slave communication devices is performed by setting in a park mode.
